(19) United States
(12) Patent Application Publication
(10) Pub. No.: US 2013/0141670 A1
(43) Pub. Date: Jun. 6, 2013

(54) Backlight Module and Liquid Crystal Display Device

(71) Applicants: Ruilian Yang, Shenzhen (CN); Pangling Zhang, Shenzhen (CN)

(72) Inventors: Ruilian Yang, Shenzhen (CN); Pangling Zhang, Shenzhen (CN)

(21) Appl. No.: 13/378,097

(22) PCT Filed: Dec. 6, 2011
(86) PCT No.: PCT/CN2011/083580

§ 371 Date: Dec. 14, 2011

(30) Foreign Application Priority Data
Dec. 2, 2011 (CN) 2011103963137

(51) Int. Cl. G02F 1/1335; F21V 7/04; F21V 8/00

(52) U.S. Cl. 349/69; 362/612; 362/609

(57) ABSTRACT

The present invention discloses a backlight module and a Liquid Crystal Display (LCD) device. The backlight module comprises an aluminum extrusion, a light bar, a member and a Light Guide Plate (LGP), wherein, the aluminum extrusion is provided with the member, and the light bar is provided with several LED lights; the backlight module also comprises a member with the light reflection function, matching holes for holding the LED lights are arranged on the member, and the member is arranged on the aluminum extrusion. The light bar is supported on the member and is jointed on one side of the member, and the LED lights are correspondingly sheathed in the mating holes. The light incident surface of the LGP is jointed on the other side of the member, and light emitting surfaces of the several LED lights are adjacent to the light incident surface of the LGP. The member of the backlight module of the present invention has the functions of light reflection and heat insulation, thereby replacing reflector plates on the rubber frame and the aluminum extrusion of the traditional backlight structure and the rubber object on the aluminum extrusion. The structure is simple and can increase the utilization ratio of the light.

### TECHNICAL FIELD

The present invention relates to a backlight module of electronic products, and more particularly to a backlight module and a Liquid Crystal Display (LCD) device.

### BACKGROUND

As the display component of an electronic device, an LCD device is now widely applied in various electronic products, and a backlight module is one of the important components of the LCD device. As shown in FIG. 1, an existing traditional LED edge type backlight module includes a Light Guide Plate (LGP) 11 and an LED light 12 arranged on one side of the LGP, wherein, the LGP 11 is fixed on the LED light 12 by the matching of a aluminum extrusion 13 and a rubber frame 14 and is supported on the aluminum extrusion 13. The LED light 12 is arranged on the aluminum extrusion 13 and is located on one side of the LGP 11. To increase the utilization ratio of the light of LED light 12, reflector plates 15 are added right above and right below the light emitting surface of the LED light 12, i.e. reflector plates 15 are respectively added on the corresponding position of the aluminum extrusion 13 and the rubber frame 14, and to prevent the aluminum extrusion 13 from conducting the heat to the LGP 11 to result in the expansion of the LGP 11, a rubber object 16 is added to the aluminum extrusion 13 to support the LGP 11, thereby performing the heat insulation function.

However, in the LED edge type backlight module, because of the small space between reflector plates 15 right above and right below the LED light 12, the operation is difficult and is time consuming; although shortening the distance between the LGP 11 and the light emitting surface of the LED light 12 can perfectly increase the utilization ratio of the light source, the distance between the LGP 11 and the light emitting surface of the LED light 12 is impossible to be infinitesimal; given that the LGP 11 heated and expended may bump into the LED light 12, resulting in the failure of the LED light 12, a certain distance must be remained between the LGP 11 and the light emitting surface of the LED light 12, however, the distance is disadvantageous for increasing the utilization ratio of the light source; the rubber object 16 added on the aluminum extrusion 13 can isolate the heat conduction to the LGP 11, however, the rubber object is costly and the adding of the rubber object is time consuming, which is disadvantageous for the cost reduction.

### SUMMARY

In consideration of above contents, one aim of the present invention is to provide a backlight module to increase the utilization ratio of the light source and simultaneously reduce the cost.

The aim of the present invention is achieved by the following technical scheme: a backlight module and an LCD device comprise an aluminum extrusion, a light bar, a member and an LGP, wherein, the aluminum extrusion is provided with the member, and the light bar is provided with several LED lights. The backlight module also comprises a member with the light reflection function, matching holes for holding the LED lights are arranged on the member, and the member is arranged on the aluminum extrusion. The light bar is supported on the member and jointed on one side of the member, and the LED lights are correspondingly sheathed in the mating holes. The light incident surface of the LGP is jointed on the other side of the member, and light emitting surfaces of the several LED lights are adjacent to the light incident surface of the LGP.

Wherein, the LGP is supported on the member, and the contact place between the member and the LGP is made of the heat insulating material.

Wherein, the member is provided with multiple matching holes with the number corresponding to that of the LED lights on the light bar.

Wherein, the member comprises a footwall and a matching wall protrudingly arranged on the footwall, and the matching wall is provided with several matching holes.

Wherein, the several matching holes are linearly arranged at equal intervals with each matching hole through both sides of the matching wall.

Wherein, the member comprises a supporting wall protrudingly arranged on the footwall, wherein, the matching wall is parallel to the supporting wall and higher than the supporting wall, and the supporting wall supports the LGP.

Wherein, the matching wall is arranged on one side of the adjacent footwall, and an end edge which supports the light bar is formed by the footwall and the side.

Wherein, the light bar comprises a main plate and the several LED lights arranged on the main plate, and the several LED lights are linearly and protrudingly arranged on the main plate at equal intervals.

Wherein, the aluminum extrusion comprises a bottom plate and a side plate vertically connected to the bottom plate. The bottom plate supports the member, and the light bar is arranged between the matching wall and the side plate.

Wherein, the light incident surface of the LGP is jointed to the side of the matching wall and is adjacent to the light emitting surface of the LED light; the inner wall of the matching hole has the function of light reflection, so that the light emitted by the LED light is reflected into the LGP.

Wherein, a top edge is formed on one top of the matching wall, and the top edge is on the same side of the end edge and parallel to the end edge.

Wherein, the member is made of the material with reflection function, or is made by applying the coating with reflection function on the base material.

An LCD device comprises one of the aforementioned backlight modules.

The benefit of the present invention: different from the existing technology, the member in the backlight module of the present invention has the light reflection function, thereby replacing reflector plates on the rubber frame and the aluminum extrusion of the traditional backlight structure; and the light incident surface of the LGP directly contacts the member, so that the distance between the LGP and the light emitting surface of the LED light can be reduced infinitely to increase the utilization ratio of the light; in addition, the member is heat insulated and directly supports the LGP to prevent the aluminum extrusion from conducting the heat to the LGP to result in the expansion of the LGP, without supporting the LGP on the rubber object of the aluminum extrusion.

### BRIEF DESCRIPTION OF FIGURES

FIG. 1 is a schematic diagram of a section of an existing backlight module;

FIG. 2 is a schematic diagram of a decomposition of a first preferred example of a backlight module of the present invention;

FIG. 3 is a structural diagram of an assembled backlight module as shown in FIG. 1;

FIG. 4 is a schematic diagram of a section of a backlight module as shown in FIG. 3;

FIG. 5 is a schematic diagram of an amplified location of a member;

FIG. 6 is a schematic diagram of a decomposition of a second preferred example of a backlight module of the present invention;

FIG. 7 is a structural diagram of an assembled backlight module as shown in FIG. 5;

FIG. 8 is a schematic diagram of a section of a backlight module as shown in FIG. 6;

FIG. 9 is a schematic diagram of another amplified location of a member;

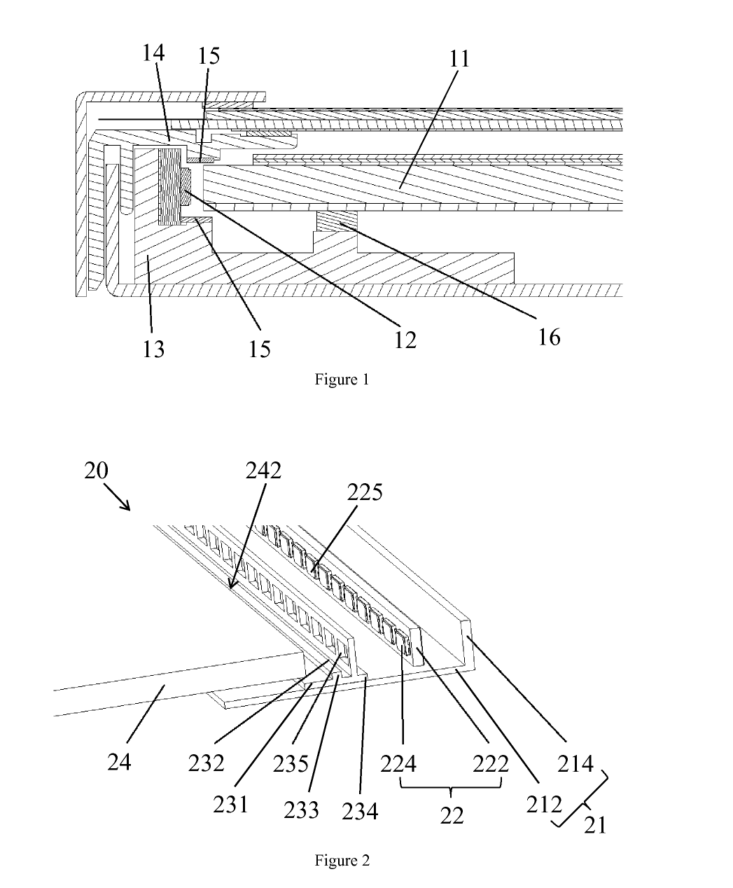

### DETAILED DESCRIPTION

The technology, the structural feature, and the aim and effect achieved of the present invention will be described in detail in accordance with the examples and the figures.

As shown in FIG. 2, a backlight module 20 of a first preferred example of the present invention comprises an aluminum extrusion 21, a light bar 22, a member 23 and an LGP 24.

The aluminum extrusion 21 comprises a bottom plate 212 and a side plate 214 vertically connected to the bottom plate 212. The member 23 is supported on the bottom plate 212.

The light bar 22 comprises a main plate 222 and several LED lights 224 arranged on the main plate 222. In the example, the main plate 222 is of rectangular bar shape, and the several LED lights are linearly and protrudingly arranged on the main plate 222 at equal intervals. Each LED light 224 has a light emitting surface 225.

The member 23 has the heat insulation function and the surface of the member has the light reflection function, and the member can be made of the material with heat insulation and light reflection function, or be made by applying the coating with heat insulation and light reflection function on the base material. The member 23 comprises a footwall 231, and a matching wall 232 and a supporting wall 233 which are protrudingly arranged on the footwall 231. The matching wall 232 is parallel to the supporting wall 233 and is higher than the supporting wall 233. The matching wall 232 is arranged on one side of the adjacent footwall 231, and forms an end edge 234 for supporting the light bar 22 with the side. The matching wall 232 is provided with several matching holes 235 with the number corresponding to that of the LED lights 224, and the several matching holes 235 are linearly arranged at equal intervals with each matching hole 235 through both sides of the matching wall 232. The several matching holes 235 are used for correspondingly and respectively sheathing LED lights 224 of the light bar. The shape of the matching holes 235 corresponds to the external contour of LED lights 224, In the example, the matching holes 235 are rectangular through holes. The supporting wall 233 is protrudingly arranged on the side of the footwall 231 corresponding to the end edge 234 to support the LGP 24.

The LGP 24 performs an light guide function on the light, and has a light incident surface 242 for matching the light emitting surface 225 of the LED light 224, so that the light enters. In the example, the LGP 24 is of rectangular block shape.

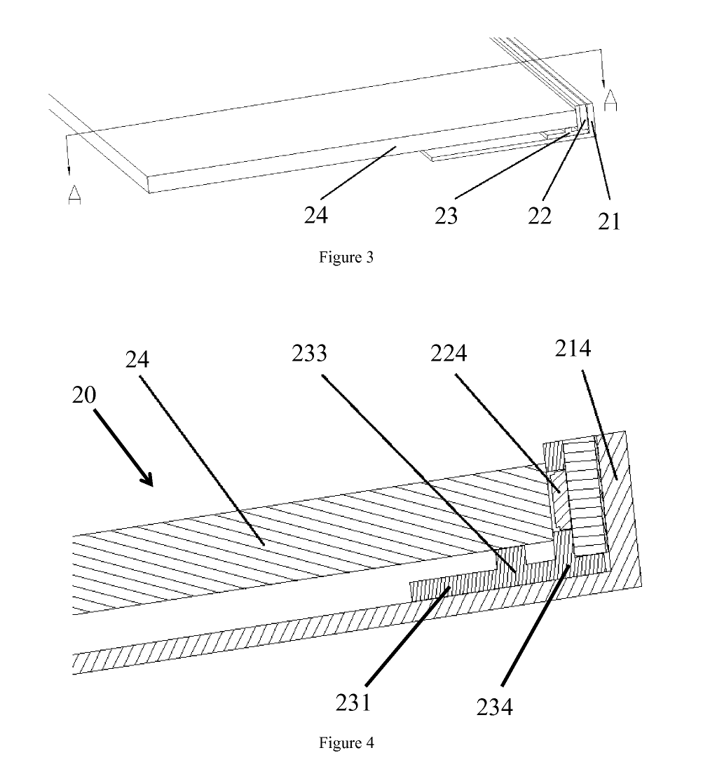

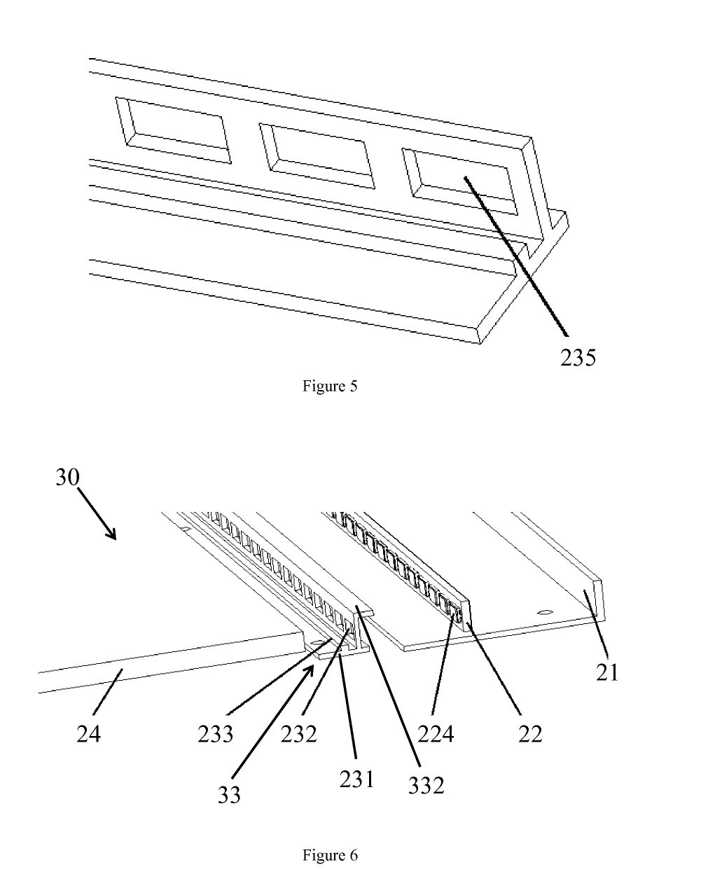

As shown in FIG. 3, FIG. 4 and FIG. 5, when the backlight module 20 is arranged, the light bar 22 is arranged on the end edge 233 of the member 23. Each LED light 224 on the light bar 22 is correspondingly sheathed in the matching hole 235, and the LED light 224 does not protrude from the matching hole 235. The light emitting surface of the LED light 224 is adjacent to the other side of the matching wall 232. The member 23 is arranged on the bottom plate 212 of the aluminum extrusion 21, and the light bar 22 is arranged between the matching wall 232 and the side plate 214 with the side corresponding to the LED light 224 against the side plate 214 of the aluminum extrusion 21. After the LGP 24 is arranged, the supporting wall 233 supports the LGP 24, and the light incident surface 242 of the LGP 24 is jointed to the side of the matching wall 232 and is adjacent to the light emitting surface 225 of the LED light 224.

When the LED light 224 is emitting the light, the member 23 has the light reflection function and matches with the hole wall in the matching hole 235 to reflect the light, so that the light emitted by the LED light 224 fully enters the LGP 24, therefore, the member 23 can replace reflector plates of the rubber frame and the aluminum extrusion of the traditional backlight structure; and the light incident surface 242 of the LGP 24 directly contacts the side of the member 23, therefore, the distance between the LGP 24 and the light emitting surface 225 of the LED light 224 can be reduced infinitely to increase the utilization ratio of the light; in addition, because the member 23 is heat insulated, the member 23 can directly support the LGP 24 to prevent the aluminum extrusion 21 from conducting the heat to the LGP 24 to result in the expansion of the LGP, without supporting the LGP on the rubber object of the aluminum extrusion.

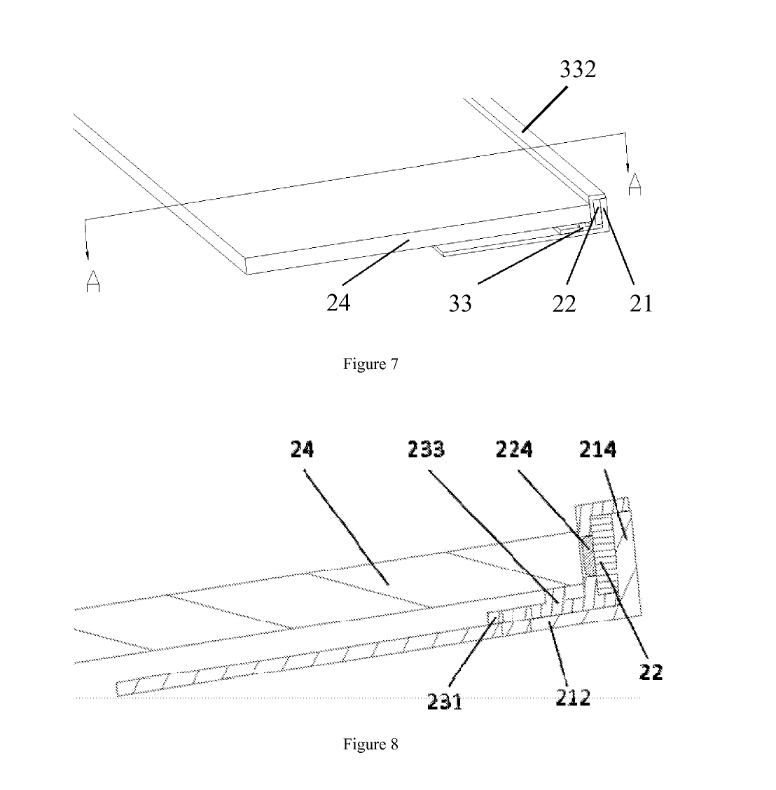

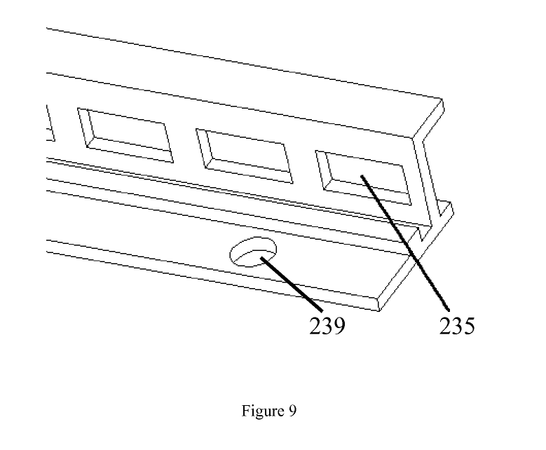

As shown in FIG. 6, FIG. 7 and FIG. 8, a second preferred example of the present invention provides a backlight module 30, and the structure of the backlight module is generally same as that of the backlight module 20 of the first preferred example. The backlight module 30 comprises the aluminum extrusion 21, the light bar 22, the member 33 and the LGP 24. The member 33 and the member 23 are about the same structure. The member 33 comprises the footwall 231, and the matching wall 232 and the supporting wall 233 which are protrudingly arranged on the footwall 231. The matching wall 232 is parallel to the supporting wall 233 and higher than the supporting wall 233. The matching wall 232 is arranged on one side of the adjacent footwall 231, and forms an end edge 234 with the side. The member 33 is different from the member 23 of the first preferred example in that: a top edge 332 is formed on one top of the matching wall 232 of the member 33 of the second preferred example, and the top edge 332 is on the same side of the end edge 234 and is parallel to the end edge 234. The footwall 231 of the member 23 is provided with an installing hole 239 fixed by matching with the bottom plate 212, as shown in FIG. 9. The top edge 332 is used to support the top surface of the side plate 214 and simultaneously support the top surface of the light bar 22 when the light bar 22 is assembled, thereby fixing the light bar 22 in the vertical direction. Therefore, the light bar 22 do not need additional fixing structures, for example, the light bar 22 is locked on the aluminum extrusion 21 by the locking screw or is sticked on the aluminum extrusion 21 by the adhesive tape.

To sum up, the member in the backlight module of the present invention has the light reflection function, thereby replacing reflector plates on the rubber frame and the aluminum extrusion of the traditional backlight structure; and the light incident surface of the LGP directly contacts the member, so that the distance between the LGP and the light emitting surface of the LED light can be reduced infinitely to increase the utilization ratio of the light; in addition, the member is heat insulated and directly supports the LGP to prevent the aluminum extrusion from conducting the heat to the LGP to result in the expansion of the LGP, without supporting the LGP on the rubber object of the aluminum extrusion.

It is understandable that the supporting wall 233 can be omitted, and the LGP 24 is directly supported on the bottom 231 of the member 23.

The examples of the present invention are only described in accordance with above contents, and the patent scope of the present invention is not limited to the examples. All equivalent structure or process changes in accordance with the specifications and the figures of the present invention, regardless of direct or indirect application in other related technical fields, are similarly considered to belong to the protection scope of the present invention.

1. A backlight module comprising: an aluminum extrusion, a light bar, an LGP and a member; said light bar is provided with several LED lights; said member has the light reflection function, and is provided with matching holes for holding the LED lights; said member is arranged on said aluminum extrusion, and said light bar is supported on the member and is jointed on one side of the member; said LED light is correspondingly sheathed in said mating holes; the light incident surface of the LGP is jointed on the other side of the member, and light emitting surfaces of said several LED lights are adjacent to the light incident surface of said LGP.

2. The backlight module of claim 1, wherein said LGP is supported on the member, the contact place between said member and the LGP is made of the heat insulating material.

3. The backlight module of claim 1, wherein said member is provided with multiple matching holes, and the number corresponds to the number of the LED lights on the light bar.

4. The backlight module of claim 1, wherein said member comprises a footwall and a matching wall protrudingly arranged on the footwall; said matching wall is provided with said several matching holes.

5. The backlight module of claim 4, wherein said several matching holes are linearly arranged at equal intervals, and each matching hole is through both sides of the matching wall.

6. The backlight module of claim 4, wherein said member comprises a supporting wall protrudingly arranged on the footwall, wherein; the matching wall is parallel to the supporting wall and is higher than said supporting wall, and the supporting wall supports said LGP.

7. The backlight module of claim 4, wherein said matching wall is arranged on one side of the adjacent footwall, and an end edge which supports said light bar is formed by the footwall and the side.

8. The backlight module of claim 1, wherein said light bar comprises a main plate and said several LED lights arranged on the main plate; said several LED lights are linearly and protrudingly arranged on the main plate at equal intervals.

9. The backlight module of claim 4, wherein said aluminum extrusion comprises a bottom plate and a side plate vertically connected to the bottom plate supporting said member; said LED light bar is arranged between the matching wall and the side plate, and the footwall of said member is provided with installing holes fixed by matching with said bottom plate.

10. The backlight module of claim 4, wherein the light incident surface of said LGP is jointed to the side of said matching wall and is adjacent to the light emitting surface of said LED light; the inner wall of the matching hole has the function of light reflection, so that the light emitted by the LED light is reflected into the LGP.

11. The backlight module of claim 7, wherein a top edge is formed on one top of said matching wall, and the top edge is on the same side of said end edge and is parallel to said end edge.

12. The backlight module of claim 1, wherein said member is made of the material with reflection function, or is made by applying the coating with reflection function on the base material.

13. An LCD device comprises a backlight module of claim 1; said backlight module comprises the aluminum extrusion, the light bar, the LGP and a member; said light bar is provided with several LED lights; said member has the light reflection function, and is provided with matching holes for holding the LED lights; said member is arranged on said aluminum extrusion, and said light bar is supported on said member and is jointed on one side of the member; said LED light is correspondingly sheathed in said mating holes; the light incident surface of the LGP is jointed on the other side of the member, and light emitting surfaces of said several LED lights are adjacent to the light incident surface of said LGP.

14. The LCD device of claim 13, wherein said LGP is supported on the member, and the contact place between said member and the LGP is made of the heat insulating material.

15. The LCD device of claim 13, wherein said member is provided with multiple matching holes with the number corresponding to that of the LED lights on the light bar.

16. The LCD device of claim 13, wherein said member comprises the footwall and the matching wall protrudingly arranged on the footwall; said matching wall is provided with said several matching holes.

17. The LCD device of claim 16, wherein said several matching holes are linearly arranged at equal intervals with each matching hole through both sides of the matching wall.

18. The LCD device of claim 16, wherein said member comprises the supporting wall protrudingly arranged on the footwall, wherein, the matching wall is parallel to the supporting wall and is higher than said supporting wall, and the supporting wall supports said LGP.

19. The LCD device of claim 16, wherein said matching wall is arranged on one side of the adjacent footwall, and an end edge which supports said light bar is formed by the footwall and the side.

20. The LCD device of claim 17, wherein said light bar comprises a main plate and said several LED lights arranged on the main plate; said several LED lights are linearly and protrudingly arranged on the main plate at equal intervals.

21. The LCD device of claim 16, wherein said aluminum extrusion comprises the bottom plate and the side plate vertically connected to the bottom plate supporting said member; said LED light bar is arranged between the matching wall and the side plate, and the footwall of said member is provided with installing holes fixed by matching with said bottom plate.

22. The LCD device of claim 16, wherein the light incident surface of said LGP is jointed to the side of said matching wall and is adjacent to the light emitting surface of said LED light; the inner wall of the matching hole has the function of light reflection, so that the light emitted by the LED light is reflected into the LGP.

23. The LCD device of claim 19, wherein a top edge is formed on one top of said matching wall, and the top edge is on the same side of said end edge and is parallel to said end edge.

24. The LCD device of claim 13, wherein said member is made of the material with reflection function, or is made by applying the coating with reflection function on the base material.
